(19) United States
(12) Patent Application Publication
(10) Pub. No.: US 2017/0128156 A1
(43) Pub. Date: May 11, 2017

(54) POSITIONING DEVICE FOR DENTAL DRILLING

(71) Applicant: Hsieh-Hsing LIN, New Taipei City (TW)

(72) Inventor: Hsieh-Hsing LIN, New Taipei City (TW)

(21) Appl. No.: 14/934,887

(22) Filed: Nov. 6, 2015

(51) Int. Cl. A61C 1/08

(52) U.S. Cl. CPC A61C 1/084

(57) ABSTRACT

A positioning device for dental drilling comprises a base and a positioning block. The base comprises an outer wall, an inner wall, a guide groove and two extension portions. The inner wall is opposite to the outer wall; the guide groove is surrounded by the inner wall; two extension portions respectively extend from two sides of the outer wall and the inner wall, an axial direction of each of the extension portions is parallel to an axial direction of the base, and a distance between the extension portions is smaller than a distance between two ends of the inner wall so that the drill will not deviate from guide groove. The positioning block protrudes from the outer wall of the base. The positioning device can be firmly embedded in the surgical guide due to the positioning block.

### BACKGROUND OF THE INVENTION

1. Field of the Invention

The present invention relates to a positioning device, particularly to a positioning device for dental drilling, wherein a distance between two extension portions is smaller than a distance between two ends of an inner wall of the positioning device.

2. Description of the Prior Arts

Teeth are calcified structure formed in the mouth for biting and chewing. An adult's teeth may be damaged by oral diseases or external forces, and the broken teeth are unable to regenerate. After the teeth are damaged, the alveolar bone and the gums of the mouth may be shrunk, and this may impair the eating capability. To avoid the above-mentioned problem, the common treatment is dental implant to replace the broken or lost teeth with denture.

When a patient's tooth is broken or missing, a notinal treatment is to replace the tooth with a denture. A common method of a denture implant is fixed tooth implant. The fixed tooth implant is processed by first drilling a socket at an appropriate position where a tooth is missing on an alveolar bone in a patient's mouth, and then an artificial implant fixture is implanted into the socket. The socket is sutured after implantation of the artificial implant fixture. When the artificial implant fixture grows fully integrated with the alveolar bone, an abutment having a screw is mounted on the artificial implant fixture. The denture is mounted on the abutment and fully sustained on the alveolar bone by the abutment and the artificial implant fixture, so the denture can bear the biting force thus to restore the biting function of the patient's teeth.

Taiwan patent number M498344, which is incorporated herein as a reference as shown in FIG. 8, discloses a drilling positioning auxiliary device for tooth implantations comprising a positioning device 90 formed in a hollow semi-cylinder. The positioning device 90 is embedded in a surgical guide in order to facilitate a drill's drilling in the alveolar bone. The semi-cylinder design allows the drill to be easily placed into the positioning device 90 in the limited oral space. However, the design also increases the instability of drilling, and the drill may be displaced due to lack of a supporting wall. Besides, the semi-cylinder design of the positioning device 90 lacks a support structure when embedded in the surgical guide, and a drilling force may separate the positioning device 90 from the surgical guide.

Therefore, to develop stable drilling for the drill and stably embedding the positioning device into the surgical guide, the disadvantages in the prior arts should be resolved.

### SUMMARY OF THE INVENTION

According to the above description, the objective of the present invention is to provide a positioning device for dental drilling for stably combining the surgical guide and supporting the drill during drilling.

The objective of the invention is to provide a positioning device for dental drilling, comprising a base and a positioning block. The base comprises an outer wall, an inner wall, a guide groove, and two extension portions. The inner wall is opposite to the outer wall; the guide groove is surrounded by the inner wall; and two extension portions respectively extend from two sides of the outer wall and two sides of the inner wall, an axial direction of each of the extension portions is parallel to an axial direction of the base, and a distance between the extension portions is smaller than a distance between two ends of the inner wall at the same plane that is perpendicular to the axis of the base. The positioning block protrudes from the outer wall of the base.

Preferably, the base is formed as a hollow semi-cylinder, and the distance between the extension portions is smaller than a diameter of the inner wall.

Preferably, the positioning block has two opposite sides, and one of the sides is connected to the outer wall of the base; a width of the positioning block perpendicular to a cross-sectional plane of the axis of the base is gradually reduced from one side of the positioning block distal from the outer wall to the other side of the positioning block connecting to the outer wall.

Preferably, the base further comprises two opposite protrusions and two opposite ends located at the axial direction of the base; each of the protrusions respectively protrudes from the outer wall and is adjacent to each of the extension portions, and each of the protrusions extends away from each other. More preferably, the protrusions are formed as slices and are adjacent to one of the ends of the base.

More preferably, the protrusions are formed as pillars.

The advantages of the present invention are:

1. The distance between the two extension portions is smaller than the distance between the two ends of the inner wall at the same plane that is perpendicular to the axis of the base so that the drill will not deviate from the guide groove, thereby increasing the stability and precision of drilling.

2. The present invention provides the positioning block so that the positioning device can be firmly embedded in the surgical guide.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of the positioning device for dental drilling of the present invention;

FIG. 2 is a plan view of the first preferred embodiment of the positioning device for dental drilling of the present invention;

FIG. 3 is a perspective view of a second preferred embodiment of the positioning device for dental drilling of the present invention;

FIG. 4 is a plan view of the second preferred embodiment of the positioning device for dental drilling of the present invention;

FIG. 5 is a perspective view of a third preferred embodiment of the positioning device for dental drilling of the present invention;

FIG. 6 is a perspective view of the second preferred embodiment and the surgical guide.

FIG. 7 shows an operational view of the second preferred embodiment and the surgical guide.

FIG. 8 is a perspective view of the drilling positioning auxiliary device for tooth implantations of the prior art and the surgical guide.

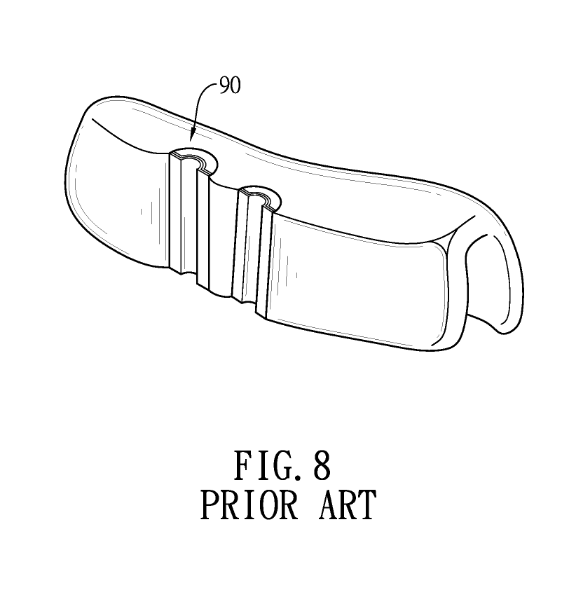

### DETAILED DESCRIPTION OF THE PREFERRED EMBODIMENTS

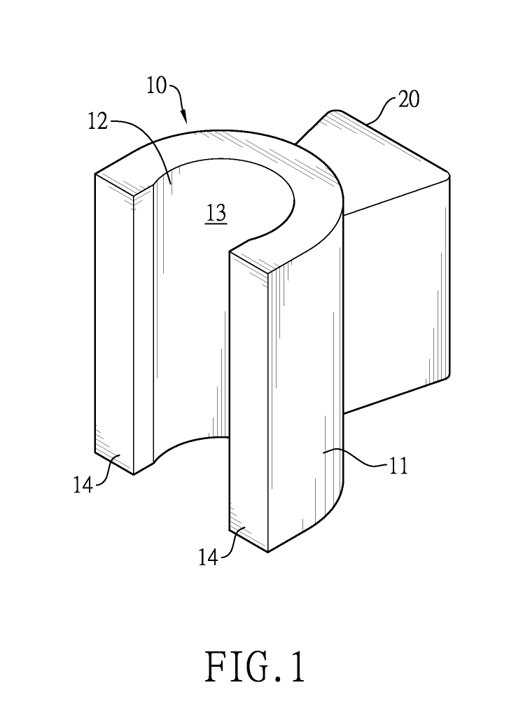

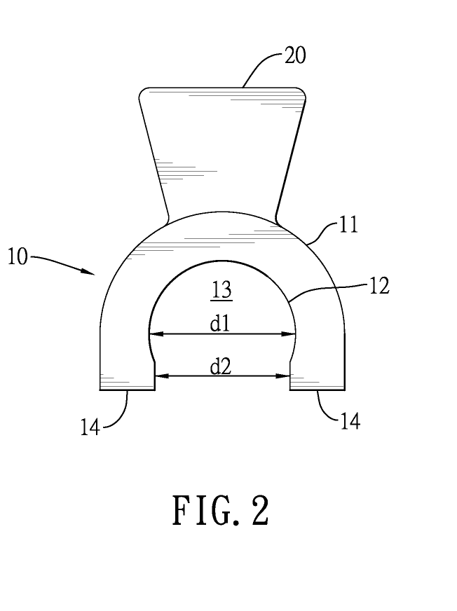

As shown in FIG. 1 and FIG. 2, the first preferred embodiment of the present invention provides a positioning device for dental drilling comprising a base 10 and a positioning block 20.

The base 10 is formed as a hollow semi-cylinder and comprises an outer wall 11, an inner wall 12, a guide groove 13, and two extension portions 14. The inner wall 12 is opposite to the outer wall 11; the guide groove 13 is surrounded by the inner wall 12; the two extension portions 14 respectively extend from two ends of the outer wall 11 and two sides of the inner wall 12, an axial direction of each of the extension portions 14 is parallel to an axial direction of the base 10, and a distance d2 between the two extension portions 14 is smaller than a diameter d1 of the inner wall 12.

The positioning block 20 protrudes from the outer wall 11 of the base 10, and the positioning block 20 has two opposite sides, one of the sides is connected to the outer wall 11 of the base 10; a width of the positioning block 20 perpendicular to a cross-sectional plane of the axis of the base 10 is gradually reduced from one side of the positioning block 20 distal from the outer wall 11 to the other side of the positioning block 20 connecting to the outer wall 11. As shown in FIG. 2, the plane view of the positioning block 20 is in a dovetail shape.

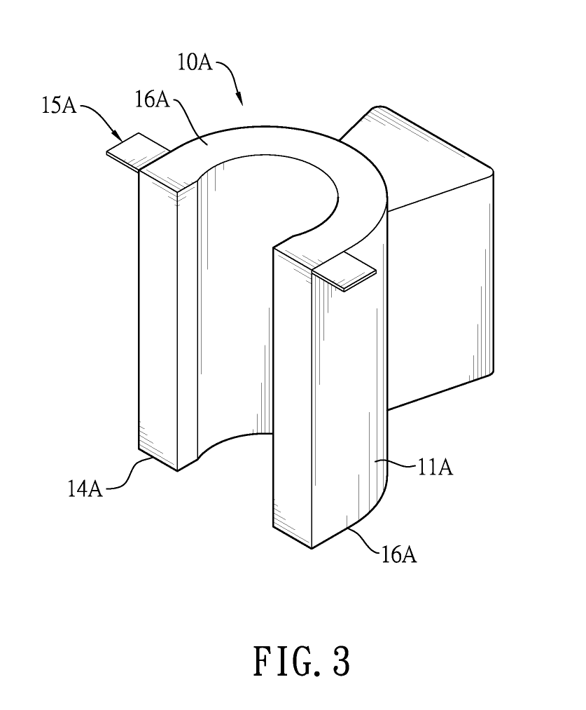

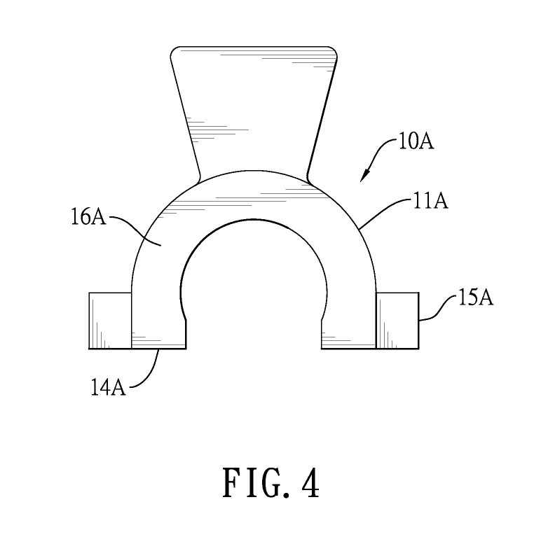

As shown in FIG. 3 and FIG. 4, the difference between the second preferred embodiment and the first preferred embodiment of the present invention is that the base 10A further comprises two opposite protrusions 15A and two opposite ends 16A located at the axial direction of the base 10A. Each of the protrusions 15A respectively protrudes from the outer wall 11A and is adjacent to each of the extension portions 14A, and the protrusions 15A extend away from each other. The protrusions 15A formed as slices and are adjacent to one of the ends 16A of the base 10A.

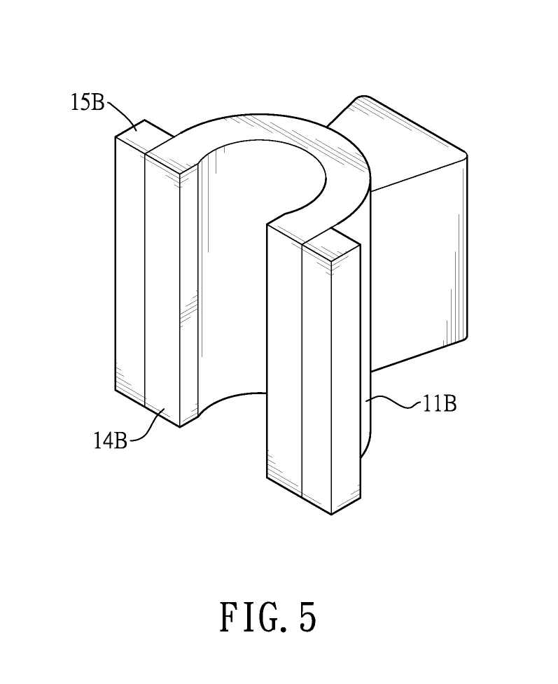

As shown in FIG. 5, the difference between the third preferred embodiment and the first preferred embodiment of the present invention is that the protrusions 15B are formed as pillars. Each of the protrusions 15B respectively protrudes from the outer wall 11B and is adjacent to each of the extension portions 14B, and the protrusions 15B extend away from each other.

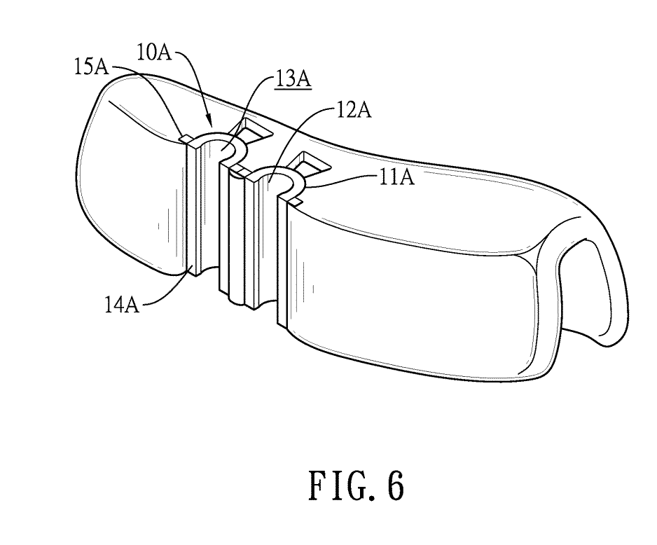

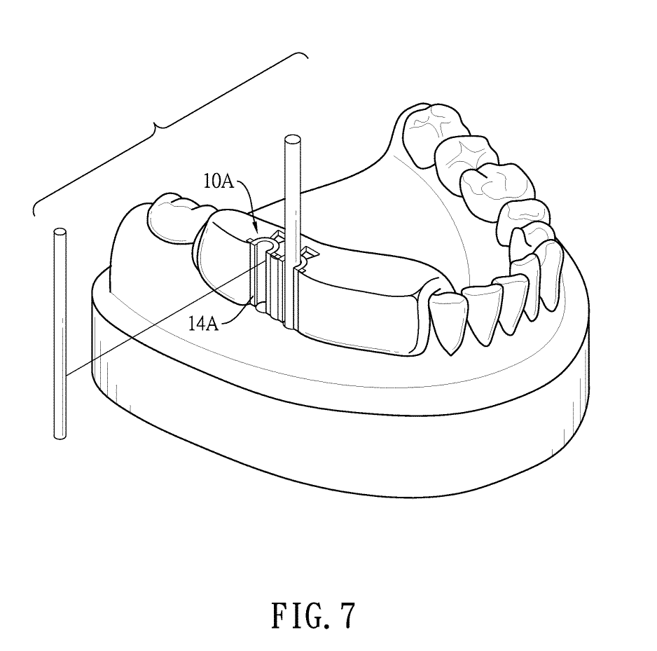

As shown in FIG. 6, when the second preferred embodiment of the present invention is in use, the positioning device for dental drilling is embedded in a surgical guide simulating a patient's teeth. When two adjacent teeth need to be implanted, two appropriate lengths of the protrusions 15A are selected after calculating a distance between teeth. The two adjacent protrusions 15A of the bases 10A are connected to each other by an end away from the outer wall 11A of each of the protrusions 15A, and then the positioning device for dental drilling is embedded in the surgical guide to reduce required times of measurements and increase the efficiency of fabrication. As shown in FIG. 6 and FIG. 7, after completing the preparation above, the surgical guide embedding the positioning device for dental drilling is covered on the patient's teeth in order to facilitate drilling in the alveolar bone. The drill goes through a space between two extension portions 14A of the base 10A into the guide groove 13A, and then the drill is drilling along the guide groove 13A toward the axis of the base 10A. Because the distance between the two extension portions 14A is smaller than the diameter of the inner wall 12A, the drill can be easily inserted into the guide groove 13A in the limited oral space, and the drill will not deviate from the guide groove 13A or toward to the extension portions 14A, thereby increasing the stability and precision of drilling.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A positioning device for dental drilling, comprising:
a base comprising:
an outer wall;
an inner wall opposite to the outer wall;
a guide groove surrounded by the inner wall; and
two extension portions respectively extending from two ends of the outer wall and two sides of the inner wall, an axial direction of each of the extension portions being parallel to an axial direction of the base, and a distance between the extension portions being smaller than a distance between two ends of the inner wall at the same plane that is perpendicular to the axis of the base; and
a positioning block protruding from the outer wall of the base.

2. The positioning device for dental drilling as claimed in claim 1, wherein the base is formed as a hollow semi-cylinder, and the distance between the extension portions is smaller than a diameter of the inner wall.

3. The positioning device for dental drilling as claimed in claim 1, wherein the positioning block has two opposite sides, and one of the sides is connected to the outer wall of the base; a width of the positioning block perpendicular to a cross-sectional plane of the axis of the base is gradually reduced from one of the sides of the positioning block distal from the outer wall to the other side of the positioning block connecting to the outer wall.

4. The positioning device for dental drilling as claimed in claim 1, wherein the base further comprises two opposite protrusions and two opposite ends located at the axial direction of the base; each of the protrusions respectively protrudes from the outer wall and is adjacent to each of the extension portions, and the protrusions extend away from each other.

5. The positioning device for dental drilling as claimed in claim 4, wherein the protrusions are formed as slices and are adjacent to one of the ends of the base.

6. The positioning device for dental drilling as claimed in claim 4, wherein the protrusions are formed as pillars.

7. The positioning device for dental drilling as claimed in claim 2, wherein the base further comprises two opposite protrusions and two opposite ends located at the axial direction of the base; each of the protrusions respectively protrudes from the outer wall and is adjacent to each of the extension portions, and the protrusions extend away from each other.

8. The positioning device for dental drilling as claimed in claim 7, wherein the protrusions are formed as slices and are adjacent to one of the ends of the base.

9. The positioning device for dental drilling as claimed in claim 7, wherein the protrusions are formed as pillars.

10. The positioning device for dental drilling as claimed in claim 3, wherein the base further comprises two opposite protrusions and two opposite ends located at the axial direction of the base; each of the protrusions respectively protrudes from the outer wall and is adjacent to each of the extension portions, and the protrusions extend away from each other.

11. The positioning device for dental drilling as claimed in claim 10, wherein the protrusions are formed as slices and are adjacent to one of the ends of the base.

12. The positioning device for dental drilling as claimed in claim 10, wherein the protrusions are formed as pillars.
